(19) United States
(12) Patent Application Publication
(10) Pub. No.: US 2022/0195816 A1
(43) Pub. Date: Jun. 23, 2022

(54) WELL PUMP WIRE CLAMP

(71) Applicants: John Bardo, Grass Valley, CA (US); Ronald Teeman, Auburn, CA (US)

(72) Inventors: John Bardo, Grass Valley, CA (US); Ronald Teeman, Auburn, CA (US)

(21) Appl. No.: 17/129,234

(22) Filed: Dec. 21, 2020

(51) Int. Cl. E21B 17/10; F16L 33/035; F16L 3/10

(52) U.S. Cl. CPC E21B 17/1035; F16L 3/1091; F16L 33/035

(57) ABSTRACT

well pump wire clamp specifically designed to mount well pump wire cable to drop pipe located in the well casing. The well pump wire clamp generally comprises a first clamping member and a second clamping member configured for interlocking around the outer surface of the drop pipe keeping the wire cable safe from breakage. The first clamp member includes a U-shaped groove wide enough for engaging the wire cable and the tongue teeth located on the tapered tongue when inserted into the head will then engage the ratchet arm. The inner circumferential clamp surface is slightly modified by including a wire pipe rib to the first clamp member and a pipe rib to the second clamp member formed longitudinally along the inner circumferential clamp surface. When the well pump wire clamp is in a clamped position, the inner circumferential clamp surface and both pipe rib in engage and prevent the separation or disengaging of the well pump wire clamp from any skewing action. The second clamp member is similar to the first clamp member wherein both members include an outer guard for the preventing excessive or abnormal drop pipe torqueing or twisting when the pump starts and stops.

### STATEMENT REGARDING FEDERALLY SPONSORED RESEARCH OR DEVELOPMENT

Not Applicable

### REFERENCE TO A “MICROFICHE APPENDIX”

Not Applicable.

### FIELD OF THE INVENTION

The present invention relates to wire clamping assembly, and in particularly, a well pump wire clamp for holding wires to the well pipe and keeps the wiring centered in the well casing.

### BACKGROUND OF THE INVENTION

If you live in a town or city, you probably don't give much thought to how the water you use each day gets to your house. Even small villages often provide a network of supply pipes that transport water to each home in the neighborhood. All you need to know is how to open the tap at the sink.

Move a few miles out of town and the picture can change. While the inner workings are still thankfully invisible, your water supply is independent from the neighbor's down the road. Each home has its own well from which to draw water. More than that, each home has its own electromechanical system for getting the water from the well to the house. At the heart of each system is a pump, and the most common types are jet pumps and submersible pumps.

Wells get drilled as far down as 1,000 feet into the rock to access the water. Water travels through this casing via a well pump. The well pump, by far one of the most important elements of any well system, the well pump is what works to suck the water up from out of the ground and then send it on its way into the pipes of your home. Casing provides support for the wall of the well so that loose rock fragments or unconsolidated sand and gravel through which the well has penetrated do not collapse into the well shaft. The casing protects the electrical wires, pull cable and water tubing/piping that are connected to the submersible pump.

Conventional wire clamps have been used to mount wire to surfaces. However, such wire clamps typically employ a metal strap to engage the wire. Improper installation or movement of the cable may cause the edge of the metal strap to cut through the cable jacket exposing interior wires to weather, water and humidity. Plastic tie wraps have also been used to mount wires to surfaces. However, tie wraps have limited pull-out strength characteristics and are not readily reusable.

Electrical tape is the most common attachment of the wires to the well pipe however Inadequate taping, poor support of the wire en route down the well, usually taped to piping, wire may not be taped sufficiently strongly or not tapes securely along the full drop of piping in the well. This is probably the most-common cause of broken or damaged pump wiring.

Wire clamps must often be applied to the pipe section in difficult conditions, and it is also important that each clamp can be applied quickly and reliably. Well pump wiring loose in the well casing invites abrasion damage, tears, breaks inside to the pump wires causing the well pump to stop working.

### BRIEF DESCRIPTION OF THE INVENTION

The primary object of the present invention is to provide well pump wire clamp for attachment to well pipes that keeps the wiring strongly secure along the full drop of piping in the well casing substantially eliminates or reduces disadvantages and problems associated with prior devices.

In order to achieve this aspect, the well pump wire clamp for protecting a wire in a well casing includes a first clamping member and a second clamping member configured for interlocking around the outer surface of the pump pipe sandwiching the wire there between.

In accordance with the present invention, each interlocking member includes a locking mechanism with a predetermined number of teeth for securely fastening both members to each other allowing the contact area between the wires and pipe to be maximized, thru affording the best possible grip on the wires and pipe.

The first clamp member includes a tapered tongue with a predetermined number of teeth and is adapted for insertion into the elongated opening head and meshing with the racket arm of the second clamp member. In addition, a U-shaped groove located on the inner surface of the first clamp member is provided to accommodate one or more wires having the same or different sizes to be held securely by the well pump wire clamp.

The second clamp member includes a head portion forming a substantially cavity opening and whereas the ratchet arm with a predetermined number of teeth engages the first interlocking member tapered tongue so as for tightening and locking together both members.

In yet another aspect of the invention, both clamp members are provided with a profiled surface guard adapted to engage the inner walls of the well casing protecting and preventing excessive or abnormal abraded and worn wire by rubbing on well casing, piping, and other contact surface.

These and other features and advantages of the invention will be readily apparent from the following detail description of an embodiment thereof and reference to the accompanying drawings.

### BRIEF DESCRIPTION OF THE DRAWING

FIG. 1 is a front perspective view of the well pump wire clamp in the preferred embodiment with the clamp in the closed position about a pipe.

FIG. 2 is a front elevation view of the well pump wire clamp shown in FIG. 1 with the clamp closed.

FIG. 3 is a front view of the two-piece well pump wire clamp provided in accordance with the principle of the present invention, shown with the pipe and wires therein.

FIG. 4 is a cut-a-way top view of the second clamp member showing the ratchet arm and teeth of the present invention.

FIG. 5 is a cut-a-way front view of the second clamp member showing the ratchet arm and teeth of the present invention.

FIG. 6 is a fragmentary section view of the well pump wire clamp head portion similar to FIG. 4 but with the tapered tongue end having the ratchet teeth inserted therein and locking mechanism in the locking position.

FIG. 7 is a perspective view of the first clamp member shown in FIG. 1.

FIG. 8 is a perspective view of the second clamp member shown in FIG. 1.

FIG. 9 is a perspective view of the well pump wire clamp if FIG. 1 in an open configuration and with a pipe and wires inserted within the pipe receiving opening of the clamp.

### DESCRIPTION OF CERTAIN EMBODIMENT OF THE PRESENT INVENTION

In the following detailed description of the preferred embodiment, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention. assembly.

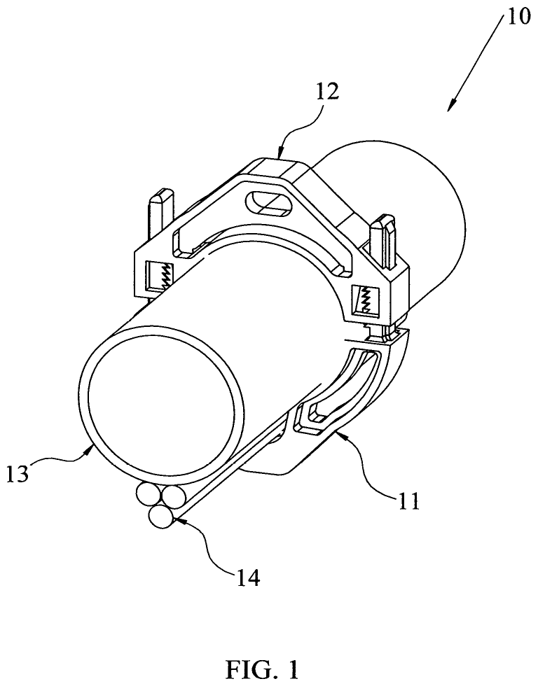

The present invention shown in FIG. 1 illustrate the well pump wire clamp 10 specifically designed to mount well pump wire cable 14 to drop pipe 13 located in the well casing (not shown). The well pump wire clamp generally comprises a first clamping member 11 and a second clamping member 12 configured for interlocking around the outer surface of the drop pipe 13 keeping the wire cable 14 safe from breakage.

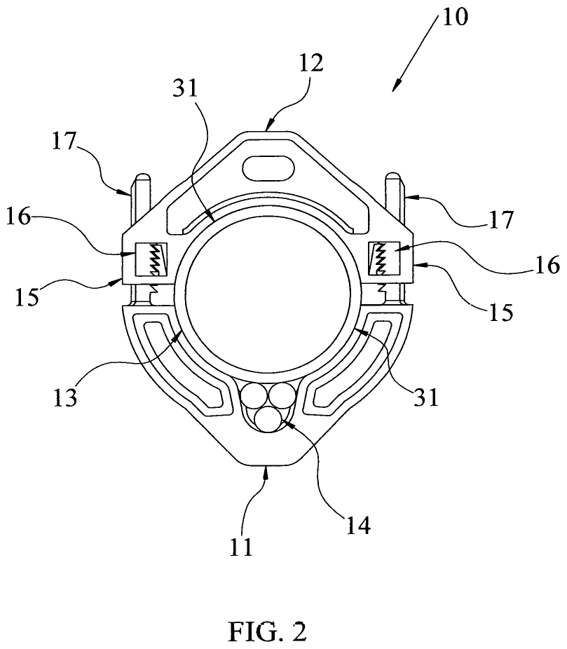

As shown in FIG. 2, is a front view of the well pump wire clamp 10 comprises a first clamp member 11 and a second clamp member 12 together in a closed position about a drop pipe 13 and the wire cable 14 engaging the interlocking mechanism 16 by way of the tapered tongue 17 and the second clamp member head 15.

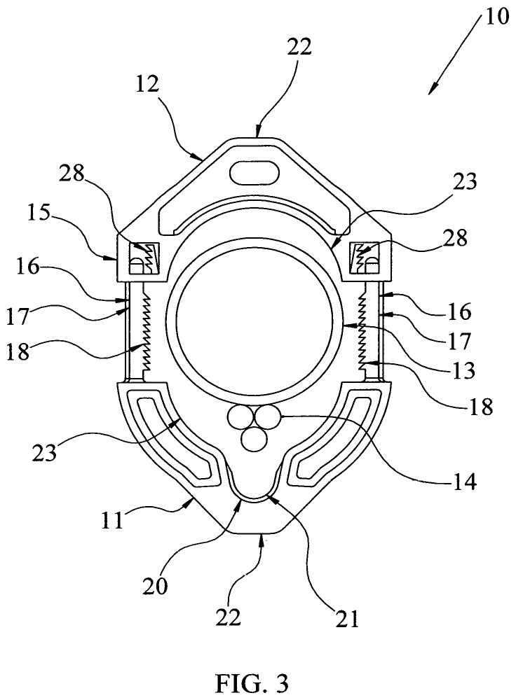

More specifically, as shown in FIG. 3, a front view of the well pump wire clamp 10 showing first clamp member and a second clamp member 11, 12 respectively, located around the drop pipe 13 and wire cable 14 in the open position before engaging the interlocking mechanism 16. The first clamp member 11 includes a U-shaped groove 20 wide enough for engaging the wire cable 14 and the tongue teeth 18 located on the tapered tongue 17 when inserted into the head 15 will then engage the ratchet arm 28. The inner circumferential clamp surface 23 is slightly modified by including a wire pipe rib 21 to the first clamp member 11 and a pipe rib 27 to the second clamp member 12 formed longitudinally along the inner circumferential clamp surface 23. When the well pump wire clamp 10 is in a clamped position, the inner circumferential clamp surface 23 and both pipe rib 21,27 in engage and prevent the separation or disengaging of the well pump wire clamp 10 from any skewing action. the second clamp member 12 is similar to the first clamp member 11 wherein both members include an outer guard 22 for the preventing excessive or abnormal drop pipe 13 torqueing or twisting when the pump (not shown) starts and stops. Another similarly to the first clamp member 11 wherein a protruding pipe rib 27 is formed on the inner circumferential clamp surface 23 and extent lengthwise with respect to the engaging the drop pipe 13 locking the clamp in place.

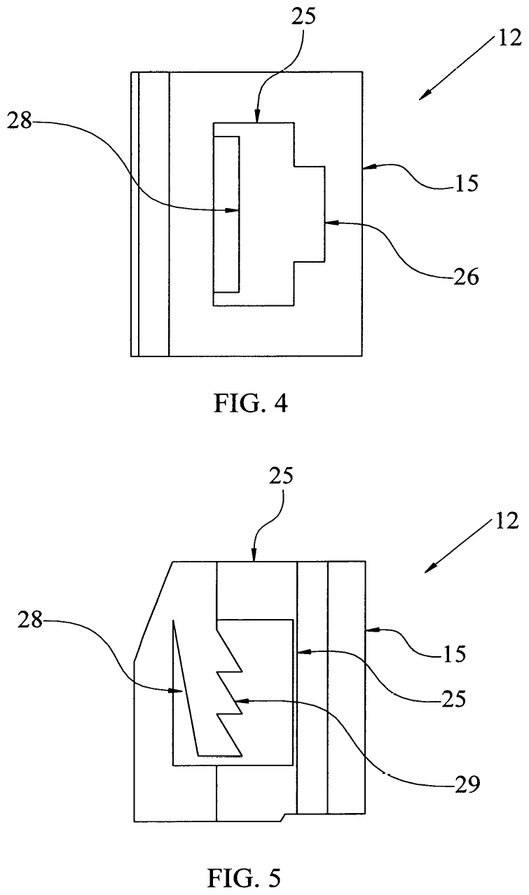

As shown in FIG. 4, is a cut-a-way top view of the second clamp member 12 having an cavity opening 25 with a guide slot 26 located in the head 15 designed for the tapered tongue 17 (not shown) to be inserted for engaging the ratchet arm 28.

substantially, shown in FIG. 5, a cut-a-way side view of the second clamp member 12 having an cavity opening 25 in the head 15 wherein the ratchet arm 28 includes a predetermined number of ratchet teeth 29.

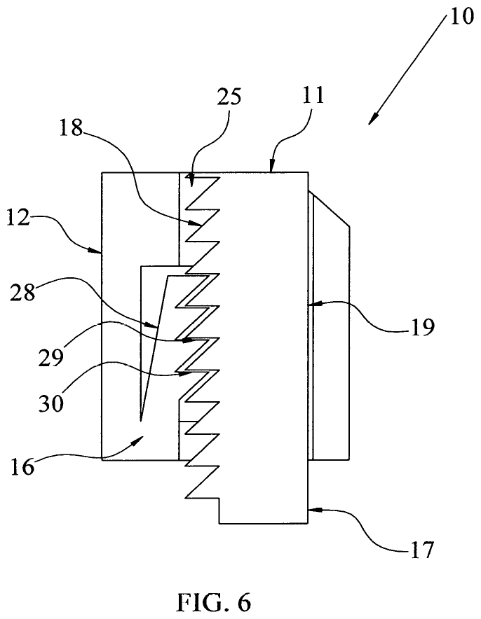

More specifically, as shown in FIG. 6 a sectional view of the well pump wire clamp 10 engaged in a clamping position. The operation and structure the interlocking mechanism 16 made up of first clamp member 11 and a second clamp member 12 component pieces each of substantially identical to FIG. 1. The first clamp member 11 includes a tapered tongue 17 with a predetermined number of teeth 18 and a guide rail 19 is adapted for insertion into the second clamp member 12 cavity opening 25 meshing with the ratchet arm 28. Once the tongue teeth 17 and the ratchet teeth 29 become engaged 30 in the locking position.

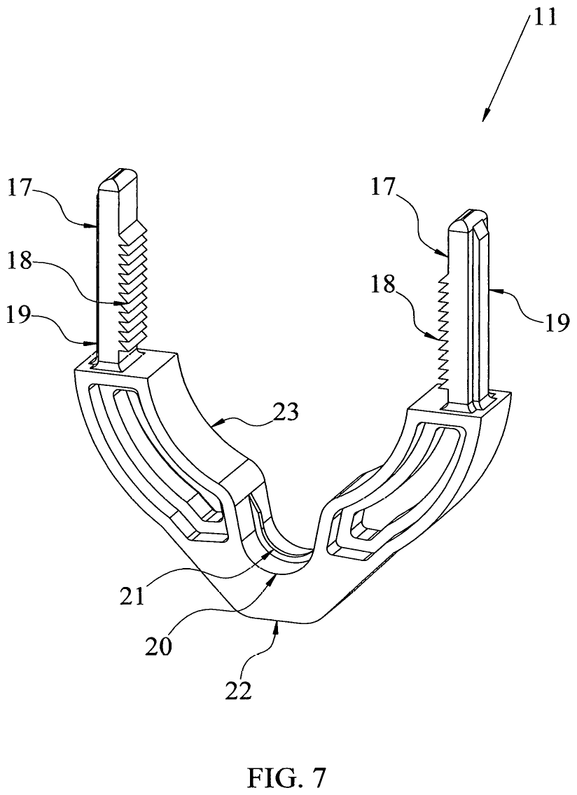

As best seen in FIG. 7, a perspective view of the plastic rigid construction first clamp member 11 including the outer guard 22 located at the bottom end of the U-shaped groove 20. The present invention consisting of U-shaped groove 20 and an inner circumferential clamp surface 23 having the wire pipe rib 21 with the end surface angle 24, angled with respect to the perpendicular of the drop pipe 13 (not shown) surface. In addition, FIG. 7 is shown having two a tapered tongue 17 with teeth 18 and guide rail 19 for insertion into the second clamp member 12 (not shown).

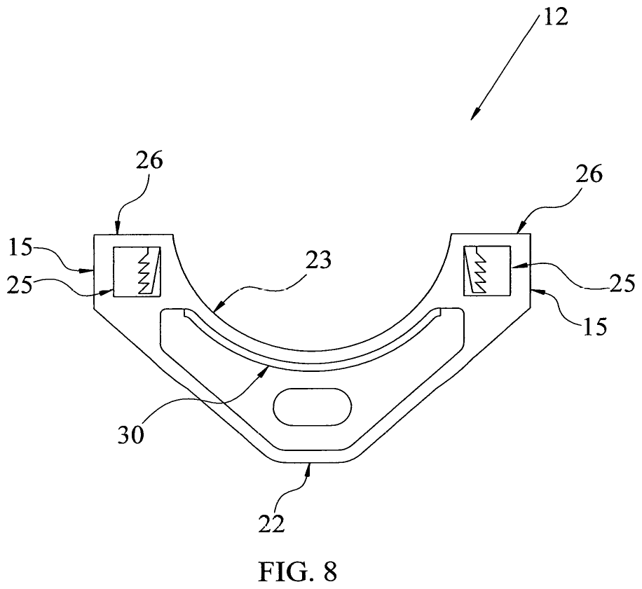

as shown in FIG. 8 a perspective view of the plastic rigid construction second clamp member 12 including the outer guard 22 located at the top the present invention. In addition, The inner circumferential clamp surface 23 having the pipe rib 27 with the end surface angle 24, angled with respect to the perpendicular of the drop pipe 13 (not shown) surface. Second clamp member 12 also includes a cavity opening 25 with a guide slot 26 located in the head 15 designed for the tapered tongue 17 (not shown) to be inserted

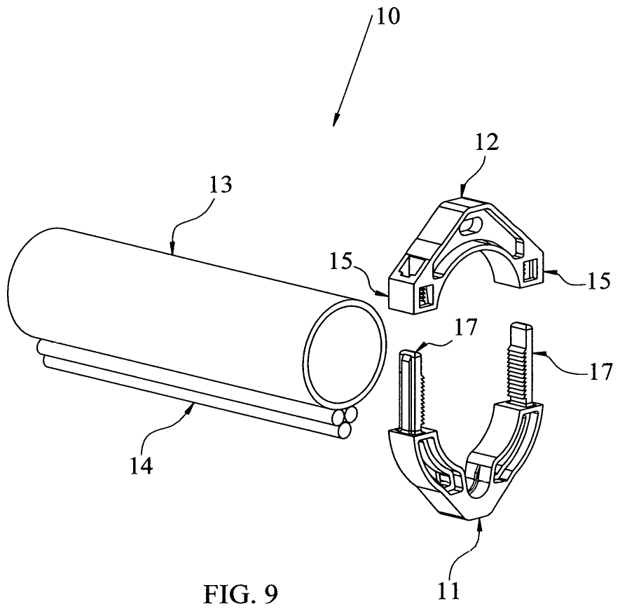

More specifically, as shown in FIG. 9 illustrate the well pump wire clamp 10 showing the first clamp member 11 before being attached to the second clamp member 12 in relationship to being attached to both the drop pipe 13 and wire cable 14 by means of the interaction of inserting the tapered tongue 17 of the first clamp member 11 into the head 15 of the second clamp member 12 locking the wire cable 13 to the drop pipe 14.

1. A two piece well pump wire clamp for holding wires to the drop pipe and keeping the wiring strongly secure along the full drop of piping in the well casing comprising:
a first clamping member and a second clamping member configured for interlocking around the outside diameter of the drop pipe to form a complete 360-degree seal securing the wire to the drop pipe;
a pair of tapered tongues of the first member with a predetermined number of teeth for insertion into the second clamp member head to engage with the ratchet arms of the second member developing opposing forces against the ratchet arms to maintain the teeth in engagement when both members are interlocked;
a U-shaped groove including a ribbed tip project outward from the U-shaped groove of the first member to accommodate one or more wires to be held securely by the well pump wire clamp.

2. (canceled)

3. The well pump wire clamp of claim 1, wherein the dual-locking mechanism includes a ratchet arm on both sides of the second member project radially toward its associated tongue teeth to prevent transverse disengagement of said teeth when the clamp is engaged.

4. A clamp as claimed in claim 1, in which the first member is provided with a ribbed surface is defined by a triangular shaped-wedge, the wedge having a tip and a base, the thickness of the tip being less than the thickness of the base, the base being place upon the groove side, while the tip project outward from groove side for engagement around a wire located in the u-shaped groove.

5. The well pump wire clamp of claim 1, wherein a pair of tongues on first members include a longitudinal guide rail to engage a groove disposed longitudinally in the adjacent head of second member when the well pump wire clamp is engaged.

6. The well pump wire clamp of claim 1, wherein both members include a protruding support element adapted to guard the wires in a substantially centered position.

7. The well pump wire clamp of claim 1, wherein an extension groove is built into the second member to move against the outside diameter of the drop pipe to form a seal that holds the second and first member closer together.
